(19) United States
(12) Patent Application Publication
(10) Pub. No.: US 2026/0163466 A1
(43) Pub. Date: Jun. 11, 2026

(54) Independent Current Balancing in Phase Combiners

(71) Applicant: Arista Networks, Inc., Santa Clara, CA (US)

(72) Inventor: Charles M. Aden, Berkeley (CA)

(21) Appl. No.: 18/976,803

(22) Filed: Dec. 11, 2024

(51) Int. Cl. H02M 1/08; H02M 3/158

(52) U.S. Cl. CPC H02M 1/08; H02M 3/158

(57) ABSTRACT

Each power stage in paired power stage design incorporates PWM (pulse width modulation) adjustment logic to generate a local (internal) PWM control signal by modulating an external PWM control signal received from a PWM controller. The modulation is based on the output current of the power stage, and occurs independent of the output current of other power stages with which it is paired. The locally generated PWM is used to improve the balance between the output currents of the power stages.

### BACKGROUND

Modern ASICs (application specific integrated circuit) require more power stages than typical multiphase PWM (pulse width modulation) power controllers can generally handle. A PWM power controller generates a PWM control signal to control the output of a power stage. An ASIC can require as many as 32 or more power stages on its core rail requiring 32 or more corresponding control signals, which generally exceeds the capacity of a PWM power controller.

A common solution is to gang multiple power stages in parallel and control the ganged power stages with a single PWM control signal. Typical designs, for example, connect two power stages in parallel and control the paired or paralleled power stages with one of the PWM control signals from the PWM controller. The current monitor signals from the two power stages are summed into one current signal and provided as feedback to the controller to generate the PWM control signal. Because the controller uses a single PWM control signal to control both power stages, the controller is not able to maintain balance between the output current of the two stages when a current imbalance arises, and so the output current can become substantially different between the paired power stages. At low current, the current imbalance can reach a point where one power stage sinks the current sourced by the other power stage.

Current imbalance can arise due to PWM skew. The power stages have different response times to the PWM signal. In a single power stage design, the controller's active current balancing feature compensates for this difference, but when two power stages share the same PWM signal, the controller can do nothing to correct the resulting imbalance in the pair.

Current imbalance can arise due to differences in fabrication tolerance between the power stages. The power stages have two main resistive components in the current path, the control FET (field effect transistor; high-side, top FET) and the synchronous diode FET (low-side, bottom FET). At a given duty cycle, an average FET resistance is calculated as a weighted average of their ON times and the effective output voltage is defined as the input Voltage times the duty cycle. As semiconductors, the FET resistance can vary widely in production, for example+/−40% around nominal. A low resistance power stage can be put in parallel with a high resistance power stage, and more current will flow through the low resistance part.

Current imbalance can arise due to Vout differences. When high current is flowing through the copper planes in a PCB (printed circuit board), there are voltage differences according to location. In a single power stage design, the controller balances the current in the power stage by measuring its output current and adjusting the corresponding PWM to raise or lower the voltage at the output of the power stage. When power stages are paralleled, the best the controller can do is to make sure the parallel combination delivers the desired total current.

Current imbalance can arise due to Vin differences. The input power distribution network also has different resistance and loading between the source and each power stage. Instead of each power stage getting 12V, for example, there may be several hundred millivolts drop in the path. When power stages are not paralleled, the controller adjusts the PWM for each one so that the current balances, but again, it can only arrange for the pair to deliver the right amount of current.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a system diagram illustrating a power supply in accordance with the present disclosure.

FIG. 2 is a diagram illustrating details of a phase combiner in accordance with the present disclosure.

FIG. 3 is a diagram illustrating details of a power stage in accordance with the present disclosure.

FIG. 4 show illustrative functions that can be incorporated in a PWM adjustment logic circuit in accordance with the present disclosure.

FIG. 5 is a diagram illustrating details or a n-phase combiner in accordance with the present disclosure.

FIG. 6 is a diagram illustrating details of a power stage in accordance with the present disclosure.

FIG. 7 is a high-level flow of operations in accordance with the present disclosure.

### DETAILED DESCRIPTION

The present disclosure incorporates PWM adjustment logic in each power stage of a paired (and in general n-stage) power stage configuration. The PWM adjustment logic in each power stage generates a local (internal) PWM control signal that is local to the power stage and is used to control the output current of that power stage. The PWM adjustment logic generates the local PWM control signal by modulating a common external PWM control signal from a PWM controller that is provided to the paired power stage. In accordance with the present disclosure, modulation of the common external PWM control signal is based on the output current of only the power stage itself and is not dependent on the output current of the other power stage with which it is paired.

In some embodiments, the external PWM control signal received from the controller can be adjusted according to the following:

$${PWM}_{local} = {PWM}_{external} - {I}_{out} \times k ,$$

where the scale factor k can be a constant. Each power stage can use the same scale factor k in order to split the current evenly between the two power stages. More generally in accordance with the present disclosure, PWM_{local} can be any suitable arbitrary function of PWMₑₓₜₑᵣₙₐₗ and Iₒᵤₜ such as, but not limited to, the straight line relation above.

In some embodiments, the PWM adjustment logic can further incorporate temperature. For example, a signal that reports the temperature of the hottest power stage in the system can be used to generate the local PWM control signal. This aspect of the present disclosure makes it possible for cooler power stages to increase their current output to steer current away from the hottest power stage, improving the thermal balance across all power stages in the design.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

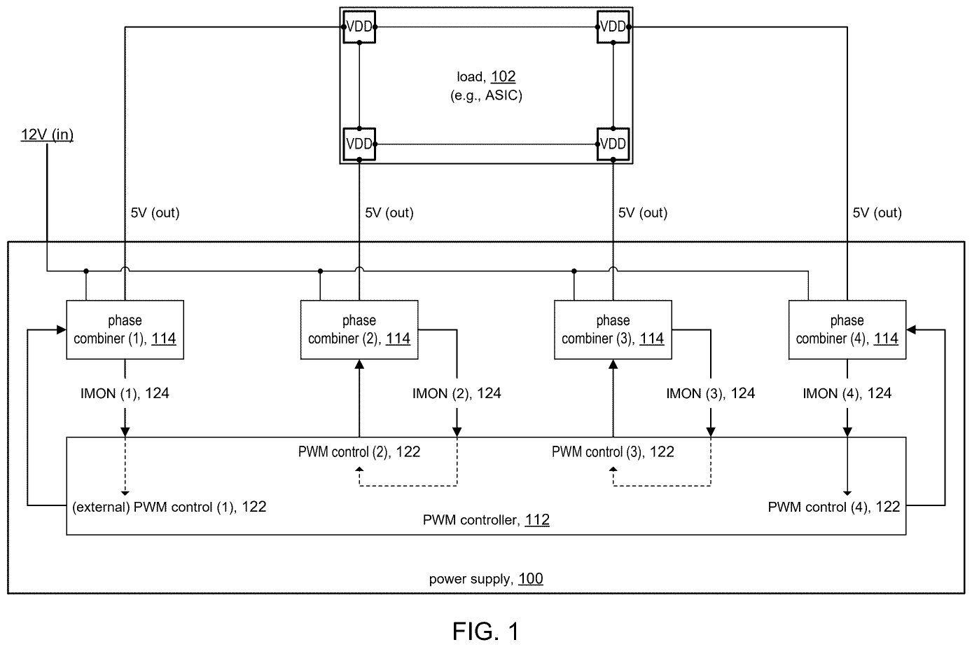

FIG. 1 is a high level diagram representing a power supply configuration that can embody the techniques in accordance with the present disclosure. Power supply 100 supplies power to a load 102, for example an ASIC core. Power supply 100 comprises a PWM controller 112 and a plurality of phase combiners 114. The output of each phase combiner 114 is electrically connected to a power terminal (e.g., VDD terminals are shorted together) of load 102. PWM controller 112 outputs a common PWM control signal 122 for each phase combiner 114. For example, the output of phase combiner (1) is controlled by PWM control signal (1), the output of phase combiner (2) is controlled by PWM control signal (2), and so on. Each phase combiner 114 outputs a monitored current signal (IMON) 124 to PWM controller 112. Monitored current signals (IMON) 124 represent the output current of the respective phase combiners. For example, monitored current signal (1) (IMON 1) represents the output current of phase combiner (1), monitored current signal (2) (IMON 2) represents the output current of phase combiner (2), and so on. PWM Controller 112 generates PWM control signals 122 for a given phase combiner 114 in a feedback loop based on the monitored output current of the given phase combiner.

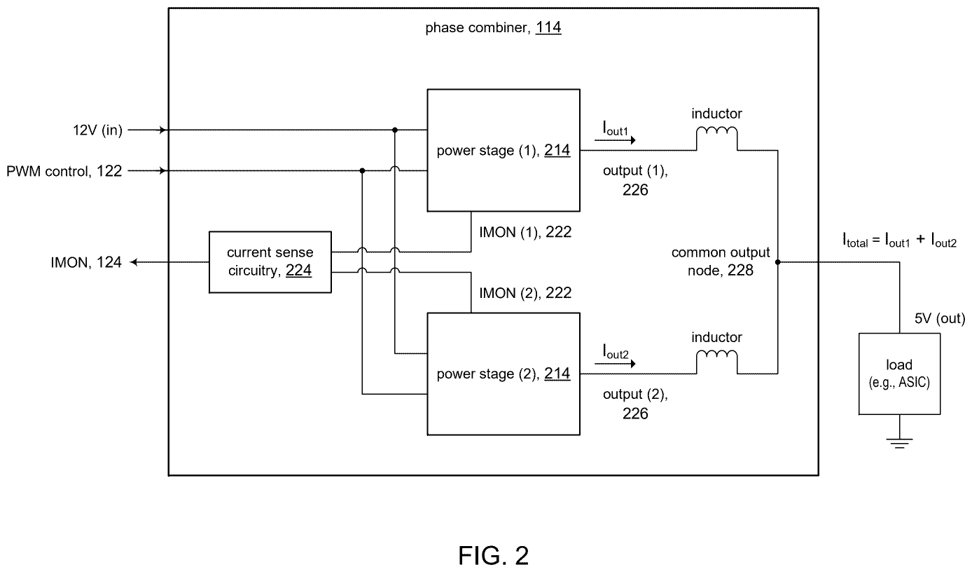

FIG. 2 shows details of phase combiner 114. In some embodiments, for example, phase combiner 114 can be a paired design comprising two power stages 214. The 12v input to phase combiner 114 drives both power stages 214. Likewise, the single externally sourced PWM control signal 122 controls the respective output currents Iₒᵤₜ₁, Iₒᵤₜ₂ of power stage (1) and power stage (2). Each power stage 214 outputs a respective local current monitor signal (IMON) 222 that represents the output current of the power stage.

Current sense circuitry 224 combines the current monitor signal 222 from each power stage 214 to produce the current signal 124, which is used by PWM controller 112 to produce PWM control signal 122. The two current monitor signals 222 are summed by current sense circuitry 224 and are seen by PWM controller 112 on one wire as IMON 124. In some embodiments, where IMON signal 222 from each power stage 214 is a current proportional to the output current, the IMON signals are summed. In other embodiments, where the monitor signal is a voltage proportional to the output current, the current sense circuitry 224 can include a resistor on each path to average them.

The respective outputs 226 of power stages 214 are connected to corresponding inductors, which in turn are connected together at common output node 228 to source a current equal to (Iₒᵤₜ₁+Iₒᵤₜ₂). Common output node 228 can be connected to provide power to a load; e.g., an ASIC.

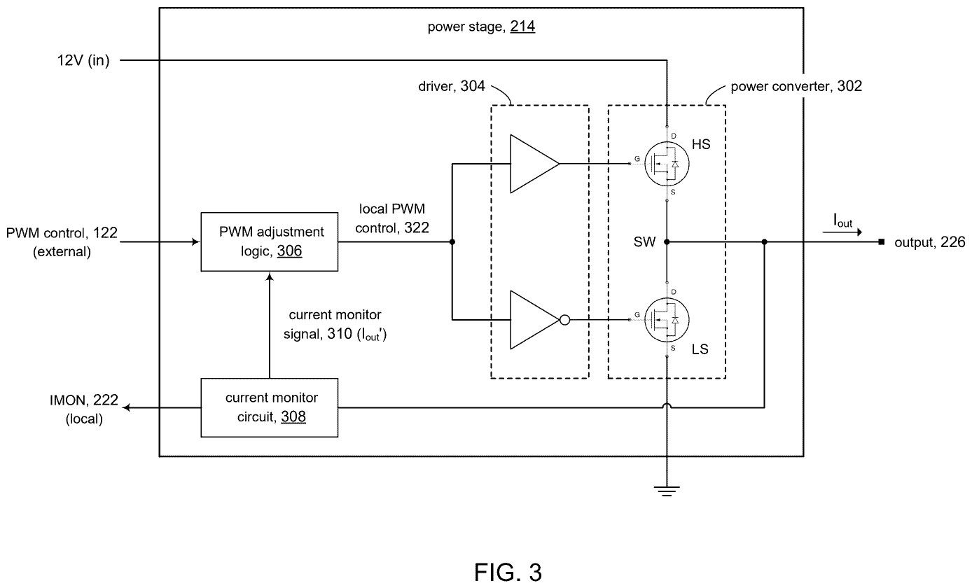

FIG. 3 is a schematic representation of power stage 214 in accordance with some embodiments of the present disclosure. Power stage 214 can be based on any suitable design. Merely to illustrate, for example, power stage 214 shown in FIG. 3 comprises a half bridge power converter 302. Power converter 302 includes a high-side switch device HS coupled between the 12V input voltage and a common switch node SW, and a low-side switch device LS coupled between the common switch node SW and a reference potential such as ground. The switch node SW is coupled to output 226 of power stage 214.

PWM adjustment logic 306 generates and adjusts local PWM control signal 322 for the high-side switch device HS and the low-side switch device LS in order to regulate the output current Iₒᵤₜ. Driver 304 converts locally generated PWM control signal 322 to an appropriate voltage signal suitable for the gates of the high-side and low-side switch devices HS, LS. The high-side switch device HS and the low-side switch device LS may be implemented using any standard type of power transistor typically used in the power stages of a power converter, such as but not limited to power MOSFETs (metal oxide semiconductor field effect transistors), IGBTs (insulated gate bipolar transistors), HEMTs (high electron mobility transistors), etc.

Current monitor circuit 308 monitors the output current at output 226 and generates current monitor signal 222. Current monitor circuit 308 also produces an internal current monitor signal 310 (Iₒᵤₜ′) that is provided to PWM adjustment logic 306. Depending on implementation, current monitor signal 222 and internal current monitor signal 310 may or may not be the same signal.

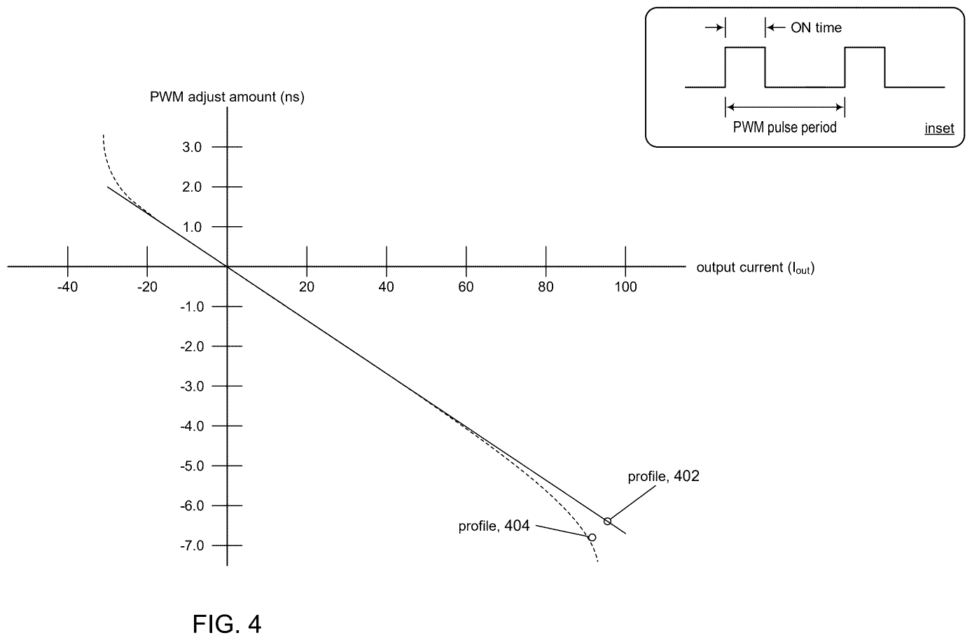

In accordance with the present disclosure, PWM adjustment logic 306 generates local PWM control signal 322 by adjusting PWM control signal 122 received from PWM controller 112 as a function of internal current monitor signal 310 which can be represented by the following adjustment function:

$${PWM}_{local} = f ( {PWM}_{external} , {I}_{out}^{′} ) ,$$

where PWM_{local} is the adjusted PWM control signal 322 (which can be expressed in terms of the ON time, see inset FIG. 4),
   PWMₑₓₜₑᵣₙₐₗ is the external PWM control signal 122, and
   f( ) represents any suitable function of PWMₑₓₜₑᵣₙₐₗ and Iₒᵤₜ′ that can maintain the output current Iₒᵤₜ at a predetermined value or values.

In some embodiments, for example, f ( ) can be:

$${PWM}_{local} = {PWM}_{external} - {I}_{out}^{′} \times k \qquad EQN . 1$$

where k is a scale factor (slope) that can be adjusted to set a predefined level for Iₒᵤₜ. As the output current Iₒᵤₜ increases (or decreases), the ON time of PWMₑₓₜₑᵣₙₐₗ is adjusted or otherwise modulated by (−Iₒᵤₜ′×k) so that local PWM_{local} controls power converter 302 to reduce (or increase) Iₒᵤₜ so as to maintain Iₒᵤₜ at a predefined value.

FIG. 4 represents illustrative examples for adjusting PWMₑₓₜₑᵣₙₐₗ as a function of the output current Iₒᵤₜ in accordance with the present disclosure. For example, profile 402 shows a straight line function where PWM adjustment logic 306 can linearly adjust the PWM (i.e., ON time) of PWMₑₓₜₑᵣₙₐₗ by about 10% as the output current Iₒᵤₜ ranges from −30 A to 100 A. For example, at 100 A, the PWM is reduced by 6.7 ns to reduce the output current, and at −30 A (i.e., the power stage sinks current), the PWM is increased by 2 ns.

Profile 404 represents an example of a non-linear response where PWM adjustment logic 306 can adjust the PWM (i.e., ON time) of PWMₑₓₜₑᵣₙₐₗ to prevent overcurrent shutdown. Typically, the entire power supply 100 is shut down when a power stage reaches the overcurrent limit. Using profile 404, PWM adjustment logic 306 can reduce the PWM of PWMₑₓₜₑᵣₙₐₗ more aggressively as the output current approaches a maximum output rating of the power stage and thus avoid an overcurrent shutdown.

In some embodiments, the graph can be expressed as data points in a look-up table that is indexed by Iₒᵤₜ′. The adjustment can then be a look-up operation which can be faster than performing a computation. A look-up table may be more practical in the case of non-linear or arbitrary functions.

Referring to FIGS. 2 and 3, in accordance with the present disclosure, PWM adjustment logic 306 in each power stage 214 can be configured with the same adjustment function (e.g., EQN. 1) and configured to use the same scale factor k. Because both PWM adjustment logic 306 in both power stages receive the same external PWM signal 122, the power stage running at higher current will reduce its current more than the power stage running at lower current, thus improving the current balance. More significantly, each power stage controls its output current Lout independently of, and without requiring information about, the output current of the other power stage. The scale factor k can be set to adjust the gain of the balancing function so that each power stage 214 tends towards outputting one half of the total output current (Iₜₒₜₐₗ) for phase combiner 114.

Referring to FIGS. 1, 2, and 3, the monitored current signal 222 from each power stage 214 can be combined into a common signal 124 that is provided to PWM controller 112. PWM control signal 122 can be generated based on signal 124 and provided to the corresponding phase combiner 114. As explained above, the PWM control signal 122 alone cannot ensure current balance between the constituent power stages 214 of the phase combiner 114. Current balance in accordance with the present disclosure can be achieved by adjusting PWM control signal 122 in each power stage 214 independently of the output current of the other power stage.

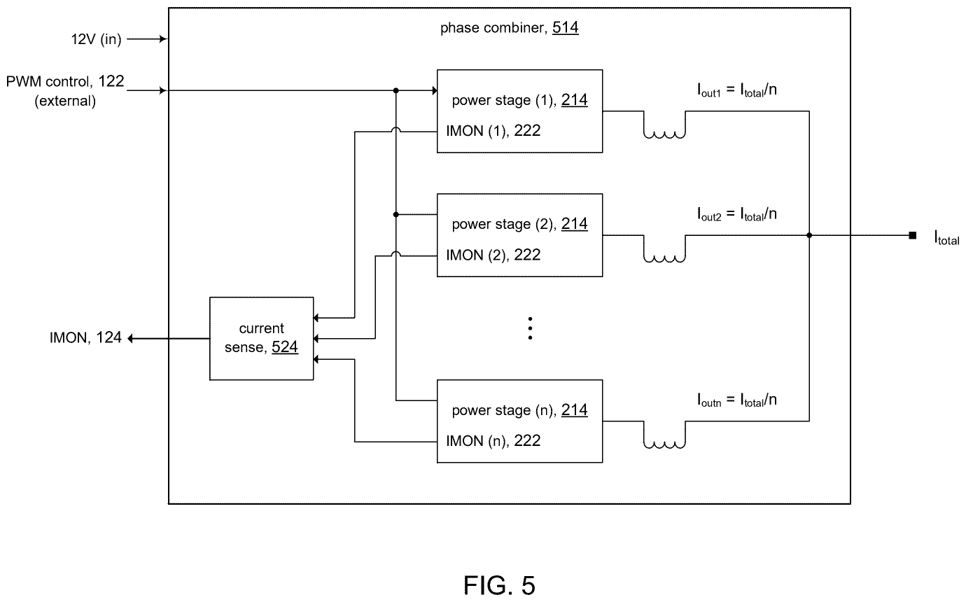

FIG. 5 illustrates an embodiment of an n-stage phase combiner 514 in accordance with the present disclosure. Each constituent power stage 214 can be embodied in accordance with the present disclosure as shown in FIG. 3. PWM adjustment logic 306 among power stages 214 can be configured to evenly divide the total output current (Iₜₒₜₐₗ) for phase combiner 514 among the power stages.

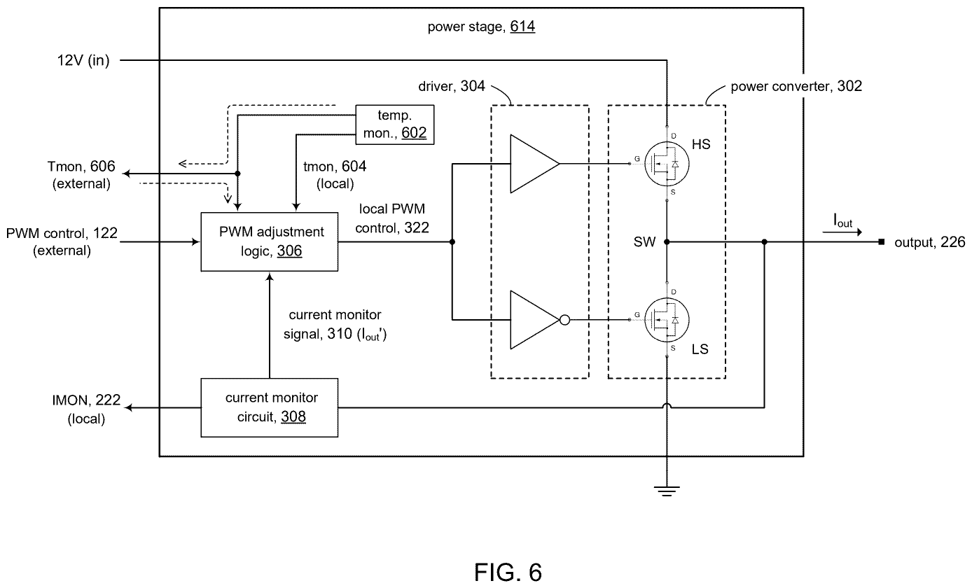

FIG. 6 is a schematic representation of a power stage 614 that incorporates temperature in accordance with the present disclosure. Power stage 614 includes a temperature monitor circuit 602 that generates a signal tmon 604 that represents the (local) temperature of the power stage. Local tmon signal 604 can be provided internally to PWM adjustment logic 306 and externally to a PWM controller (e.g., via the pin that provides external Tmon signal 606). PWM adjustment logic 306 can receive external Tmon signal 606 (e.g., from a PWM controller) that represents the highest temperature among other power stages in the system.

In some embodiments, PWM adjustment logic 306 can factor in the local tmon signal 604 and the external Tmon signal 606 to adjust the ON time of local PWM control 322 as the power stage gets hotter, to balance the temperatures. Corrections for current and temperature can be applied at the same time. Cooler power stages can increase their current output, which steers current away from the hottest power stage, improving the thermal balance across all power stages in the design.

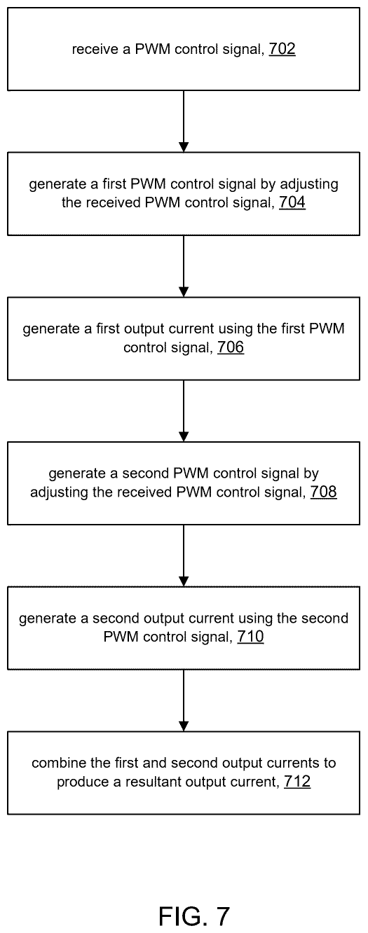

FIG. 7 represents operations performed by a phase combiner 1 (e.g., phase combiner 114) and power stages (e.g., power stages (1), (2)) in accordance with the present disclosure. At operation 702, the phase combiner can receive a PWM control signal (e.g., PWM control signal 122) from a PWM controller (e.g., PWM controller 112). At operation 704, the first power stage (e.g., power stage (1)) can generate a first PWM control signal (e.g., 322) by adjusting the received PWM control signal (e.g., using PWM adjustment logic 306). In accordance with the present disclosure, the adjustment can be based on the output current of the first stage independently of the output current of the second power stage. In some embodiments, the adjustment can take into account a temperature signal indicative of a maximum temperature of a power stage among a plurality of power stages in the system (e.g., FIG. 1). At operation 706, a first output current (e.g., output 226) can be generated using the first PWM control signal. At operation 708, the second power stage (e.g., power stage (2)) can generate a second PWM control signal (e.g., 322) by adjusting the received PWM control signal (e.g., using PWM adjustment logic 306). In accordance with the present disclosure, the adjustment can be based on the output current of the second stage independently of the output current of the first power stage. In some embodiments, the adjustment can take into account a temperature signal indicative of a maximum temperature of a power stage among a plurality of power stages in the system (e.g., FIG. 1). At operation 710, a second output current (e.g., output 226) can be generated using the second PWM control signal. At operation 712, the first and second output currents can be combined to produce a resultant output current (e.g., Iₜₒₜₐₗ).

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. Power supply circuitry comprising:
a first power stage;
a second power stage; and
an input terminal to receive a common PWM control signal and provide the common PWM control signal to both the first power stage and the second power stage; and
an output terminal that combines an output current of the first power stage and an output current of the second power stage to source an output current of the power supply circuitry,
the first power stage of the power supply circuitry including first adjustment logic to generate a first local PWM control signal by adjusting the common PWM control signal based on a first monitored signal indicative of an output current of the first power stage, wherein the first local PWM control signal controls the output current of the first power stage,
the second power stage of the power supply circuitry including second adjustment logic to generate a second local PWM control signal by adjusting the common PWM control signal based on a second monitored signal indicative of an output current of the second power stage, wherein the second local PWM control signal controls the output current of the second power stage.

2. The power supply circuitry of claim 1, wherein the first and second local PWM control signals are generated according to an adjustment function that relates PWM adjustment amount to output current.

3. The power supply circuitry of claim 1, wherein the first adjustment logic in the first power stage generates the first local PWM control signal independently of the output current of the second power stage, wherein the second adjustment logic in the second power stage generates the second local PWM control signal independently of the output current of the first power stage.

4. The power supply circuitry of claim 1, wherein the first and second adjustment logic individually adjust their usage of timing derived from the common PWM control signal to reduce current imbalance between the first and second power stages.

5. The power supply circuitry of claim 4, wherein the first and second local PWM control signals are further based on respective temperature signals indicative of the first and second power stages.

6. The power supply circuitry of claim 1, wherein the first and second local PWM control signals are further based on a temperature signal indicative of a maximum temperature among a plurality of power stages that includes the first and second power stages.

7. The power supply circuitry of claim 1, wherein the first and second adjustment logic adjust the common PWM control signal by scaling the first and second monitored signals, respectively, using a common scale factor to balance the output current between the first and second power stages.

8. The power supply circuitry of claim 1, wherein the output current of the first and second power stages are connected to the output terminal of the power supply circuitry through respective inductors.

9. The power supply circuitry of claim 1, further comprising at least a third power stage, wherein the third stage includes third adjustment logic to generate a third local PWM control signal by adjusting the common PWM control signal based on a monitored signal indicative of an output current of the third power stage, wherein the third local PWM control signal controls an output current of the third power stage.

10. The power supply circuitry of claim 1, wherein the first and second monitored signals indicate (positive) current flows that flow, respectively, out of the first and second power stages and (negative) current flows that flow, respectively, into the first and second power stages.

11. The power supply circuitry of claim 1, wherein the first and second local PWM control signals limit the output currents, respectively, of the first and second power stages from exceeding a positive current limit and a negative current limit.

12. The power supply circuitry of claim 1, wherein the common PWM control signal is generated by a power supply controller separate from the power supply circuitry.

13. A method in a power circuit, the method comprising:
receiving a PWM control signal;
controlling at least a first power stage and at least a second power stage using the received PWM control signal, wherein each power stage of the first and second power stages:
generates a local PWM control signal from the received PWM control signal based on an output current of the power stage; and
generates a local output current using the local PWM control signal; and
combining the local output current generated by each of the first and second power stages to produce a resultant output current of the power circuit.

14. The method of claim 13, wherein the generated local PWM control signal in each of the first and second power stages is generated independently of the output current of the other power stage.

15. The method of claim 13, further comprising controlling at least a third power stage using the receive PWM control signal and combining the local output current generated by each of the first, second, and third power stages to produce a resultant output current of the power circuit.

16. The method of claim 13, wherein the generated local PWM control signal in each of the first and second power stages is further based on a temperature signal indicative of a maximum temperature among a plurality of power stages that includes the first and second power stages.

17. The method of claim 16, wherein the generated local PWM control signal in each of the first and second power stages is further based on a temperature signal indicative of a temperature of the power stage.

18. The method of claim 13, wherein a timing of the local PWM control signal in each power stage is adjusted according to a function that relates PWM adjustment amount to the output current of the power stage to reduce current imbalance between the first and second power stages.

19. The method of claim 13, wherein the received PWM control signal is generated from a PWM controller separate from the power circuit.

20. The method of claim 13, wherein the received PWM control signal is generated based on the resultant output current of the power circuit.
